(19) United States
(12) Patent Application Publication
(10) Pub. No.: US 2009/0296726 A1
(43) Pub. Date: Dec. 3, 2009

(54) ACCESS CONTROL LIST MANAGEMENT IN AN FCoE ENVIRONMENT

(75) Inventors: Robert Norman Snively, Morgan Hill, CA (US); Sandra Snively, Morgan Hill, CA (US); Anoop Ghanwani, Rocklin, CA (US)

Correspondence Address: HENSLEY KIM & HOLZER, LLC, 1660 LINCOLN STREET, SUITE 3000, DENVER, CO, 80264, US

(73) Assignee: BROCADE COMMUNICATIONS SYSTEMS, INC., San Jose, CA (US)

(21) Appl. No.: 12/477,816

(22) Filed: Jun. 3, 2009

Related U.S. Application Data
(60) Provisional application No. 61/058,432, filed on Jun. 3, 2008.

(51) Int. Cl. H04L 12/56

(52) U.S. Cl. 370/401

(57) ABSTRACT

A Fibre Channel Forwarder (FCF) suspends a fabric session with a virtual machine (VM) in response to receipt of a deregister message from the virtual machine through an Ethernet bridge and transmits a deregister acceptance message to the VM. The Ethernet bridge detects the messages and updates its Access Control List (ACL) to remove the MAC address of the VM. While the fabric session is suspended, a virtual machine may migrate to another physical machine without terminating its connection to the fabric. After migration, the FCF resumes its fabric session with the VM in response to receipt of a register message from the VM through a second Ethernet bridge. The FCF responds to the register message with a register acceptance message. The Ethernet bridge detects the messages and updates its Access Control List (ACL) to add the MAC address of the VM.

### CROSS-REFERENCE TO RELATED APPLICATIONS

The present application claims benefit of priority to U.S. Provisional Patent Application No. 61/058,432, entitled “Access Control List Management in an FCoE Environment Using FIP Snooping” and filed on Jun. 3, 2008, specifically incorporated by reference herein for all that it discloses or teaches.

### BACKGROUND

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel (FC) networking is typically used in SANs although other communications technologies may also be employed, including Ethernet and IP-based storage networking standards (e.g., iSCSI, FCIP (Fibre Channel over IP), etc.).

As used herein, the term “Fibre Channel” refers to the Fibre Channel family of standards (developed by the American National Standards Institute (ANSI)) and other related and draft standards. In general, Fibre Channel defines a transmission medium based on a high speed communications interface for the transfer of large amounts of data via connections between varieties of hardware devices.

In a typical SAN, one or more Fibre Channel switches are used to communicatively connect one or more server devices with one or more data storage devices. Such switches generally support a high performance switching fabric and provide a number of communication ports for connecting to other switches, servers, storage devices, or other SAN devices. Other high performance fabrics may employ different fabric technologies, such as InfiniBand.

Other networking technologies, such as Ethernet, may also be employed in communicating between computing and networking devices. However, these networking technologies do not work seamlessly with high performance networks, such as an FC network. Nevertheless, efforts towards implementing FC networking over an Ethernet network continue with growing success.

### SUMMARY

Implementations described and claimed herein address the foregoing problems by providing for Access Control List (ACL) management in a Fibre Channel over Ethernet (FCoE) environment. ACL management may permit migration of a virtual machine between physical machines in an FCoE environment while maintaining a Fibre Channel (FC) fabric connection.

Other implementations are also described and recited herein.

### BRIEF DESCRIPTION OF THE DRAWINGS

FIG. 1 illustrates an exemplary computing and storage framework including a local area network (LAN) and a storage area network (SAN).

FIG. 2 illustrates an exemplary migration of a virtual machine (VM) from a first physical machine to a second physical machine while maintaining a Fibre Channel (FC) fabric connection.

FIG. 3 illustrates exemplary operations for managing an Access Control List (ACL) in a Fibre Channel over Ethernet (FCoE) environment.

### DETAILED DESCRIPTION

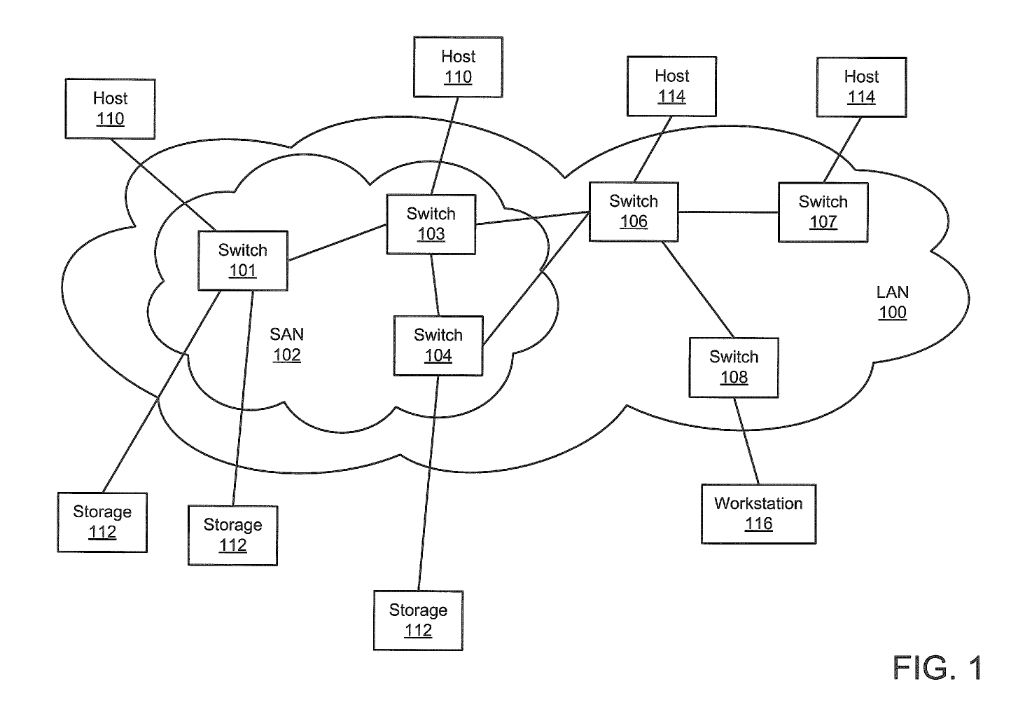

FIG. 1 illustrates an exemplary computing and storage framework including a local area network (LAN) 100 and a storage area network (SAN) 102. A local area network (LAN) 100 provides communication connectivity among multiple devices, such as hosts 114 and 116. The LAN 100 is presumed to be the network for a relevant enterprise with a number of different segments, although any LAN configuration may be employed.

A storage area network (SAN) 102 resides within the LAN 100 and provides communication connectivity, routing, and other SAN functionality among hosts 110 and storage units 112. The SAN 102 includes a number of switches, such as switches 101 and 104 and FCF 103. Such switches 101 and 104 may be configured as a set of blade components inserted into a chassis, as rackable or stackable modules, or as other device structures. In one implementation, the chassis has a back plane or mid-plane into which the various blade components, such as switching blades and control processor blades, may be inserted.

Fibre Channel Forwarder (FCF) 103 connects Ethernet bridges 106 and 108. In addition, a series of hosts 110 are connected to various switches 101 and 104 in the SAN 102. Likewise storage units, such as described storage units 112, are connected also to various switches 101 and 104 in the SAN 102.

Generally, a developing standard called Fibre Channel over Ethernet (FCoE) allows Fibre Channel (FC) frames to be transmitted and received over an Ethernet network. In one implementation, a standard FC frame is equipped with a specified FCoE header and embedded within an Ethernet frame for communication through the Ethernet network. When an FCoE frame is transmitted through the Ethernet network and reaches a properly equipped FC switch at the boundary of an FC network, the FC switch strips off the Ethernet and FCoE portions of the frame and forwards the embedded FC frame through the SAN. Likewise, when a standard FC frame is transmitted through the FC network and reaches a properly equipped FC switch at the boundary of the FC network and an Ethernet network, the FC switch adds an FCoE header and an Ethernet header (with appropriate synchronization fields) to the FC frame and forwards the newly-enhanced FCoE frame to the Ethernet network.

The Ethernet header of the FCoE frame includes source and destination L2 (layer-2) addresses, such as MAC addresses, which the Ethernet network uses to direct the frame to its intended destination. For example, hosts and other devices on the Ethernet network can receive the FCoE frame if they are configured to receive frames having the MAC address in the destination field of the Ethernet header. Typically, each host or other device maintains a list of MAC addresses it is configured to receive in addition to the broadcast address. Such MAC addresses may be uni-cast addresses or multi-cast addresses.

In addition, each host or other device also has at least one MAC address that it inserts into the source L2 address field of any frame it transmits. The source address allows a receiving device to determine the sender of a frame and, therefore, destination address to which any reply should be sent. Many hardware host bus adapters, software applications, and operating systems choose to define the MAC address that is to be used as the preferred destination address for Ethernet frames directed to the host bus adapter and as the source address for Ethernet frames transmitted from the host bus adapter. Other host bus adapters, software applications, and operating systems choose to accept a MAC address provided by the SAN switch in order to encode information otherwise provided by the SAN switch. Such encoded information may include the Fibre Channel Destination Identifier (FC_ID) of frames transmitted by the SAN switch to that host adapter.

One challenge introduced by implementing Fibre Channel over Ethernet (FCoE) is maintaining a robust level of control over traffic received and forwarded by individual switches in the FCoE network. Generally, each FC switch is considered a trusted device within the FC fabric. Other FC switches login into the switch before those switches can communicate through the switch to the rest of the FC fabric. Given that the FC links are point-to-point, each FC switch has control over the traffic it injects into the fabric and over traffic it receives from the fabric. As a result, each FC switch can enforce zoning configurations, ensure devices are using their assigned addresses, and prevent various types of anomalous behaviors (both erroneous and malicious). However, if one or more Ethernet bridges exist between an Ethernet node (ENode) and a Fibre Channel Forwarder (FCF) (a device that performs the functions of a Fibre Channel switch that may also function as a “gateway” that can bridge the boundary between an Ethernet network and a Fibre Channel network), then the point-to-point assurance between the ENode and the FCF is lost, defeating the desired robustness of a high performance network technology like Fibre Channel.

In one approach, Access Control List (ACL) features of Ethernet bridges may be employed to emulate a point-to-point link by providing traffic enforcement. Generally, ACLs restrict FCoE traffic based on configured packet filters, which apply rules to individual FCoE packets. If an FCoE packet received at a bridge matches the rule, an action associated with the rule (e.g., permit or deny forwarding through the bridge) is applied to the packet. In this manner, ACLs allow Ethernet bridges to make and enforce security decisions about FCoE traffic flowing through each Ethernet bridge.

Most ACL implementations operate on frames at ingress (referred to as ingress ACL). Some implementations can alternatively or additionally apply ACLs at egress (referred to as egress ACL). Furthermore, the FCoE Initialization Protocol (FIP) has been developed to enable Ethernet bridges to efficiently monitor FIP frames passing through them to FCF at the edge of a fabric using a technique known as “FIP snooping”. A FIP frame is identified by a special Ethertype that can easily be separated for analysis by an Ethernet bridge. Additional FIP frames are available to indicate that particular MAC addresses are no longer valid. Using FIP snooping, therefore, each Ethernet bridge can automatically configure its own ACL so as to preserve the security properties of a point-to-point link between each ENode port and each FCF port, even though there may be multiple intervening bridges. FIP snooping still results in the FIP frame being passed to the destination FCF.

ACLs may be implemented in various structures, potentially varying among different Ethernet bridges. However, in general, an ACL consists of an ordered list of rules (Access Control Entries or ACEs) that determine whether a frame should be forwarded (“permit”) or discarded (“deny”). Each rule is evaluated by comparing bits of the received frame to a bit pattern specified by the rule. The pattern may require that any bit be a one, a zero, or a “don't care”.

The frame data to which the bit pattern is applied can also vary among different implementations. In one implementation, the source MAC address, the destination MAC address, the VLAN tag, and the Ethertype fields of the frame are evaluated against the bit pattern of a rule. However, other combination of frame fields may be evaluated in other implementations.

An example rule format is shown below:

[field=value],[field=value], . . . , [action];

where each “field” evaluated is identified as one of the following:
DA: Destination MAC address field (48 bits)
DApre: 24 most significant bits of Destination MAC address (24 bits)
SA: Source MAC address field (48 bits)
SApre: 24 most significant bits of Source MAC address (24 bits)
VLAN: VLAN ID field within the VLAN tag (12 bits)
Ethertype: Ethertype field (16 bits)

In the rule format shown above, “value” represents the bit pattern against which the frame “field” is evaluated. It should be understood that other rule formats may be employed.

If the bits of a given “field” (or set of fields) of a frame match the bit pattern value (or set of bit pattern values), then the rule's “action” (e.g., permit or deny forwarding) is applied to the frame. If a frame matches multiple bit pattern(s) specified within the ACL, the first pattern satisfied identifies the action that is to be applied. A default rule may be specified in case a frame does not match any bit pattern in the ACL. Other ACL implementations may also be employed.

However, management of Access Control Lists of Ethernet bridges in an FCoE network introduces other complexities, especially when a virtual machine (VM) is connected to the FCoE network, wherein each VM is represented by a particular MAC address. Virtualization allows the VM to be moved from one physical machine to another physical machine in another part of the FCoE network, which can result in a change to the VM's connection to the fabric. That is, when the VM moves to another part in the network, the VM can connect to the fabric through a different Ethernet bridge. When such movement occurs, the ACL of the originally-connected bridge is modified to reflect the removal of the VM and the ACL of the newly-connected bridge is modified to reflect the addition of the VM.

One method of executing such modifications using existing FIP messaging is to perform an FLOGO (Fabric LOGOut) of the VM (which terminates the VM's session with the switch) through the originally-connected Ethernet bridge, then migrate the VM from one physical machine to the other physical machine, and then perform an FLOGI (Fabric LOGIn) through the newly-connected Ethernet bridge, thereby re-establishing the VM's session with the fabric. By logging out of the fabric, the VM causes the originally-connected bridge to remove the VM from its ACL, and by logging into the fabric, the VM causes the newly-connected bridge to add the VM to its ACL. However, this method is not transparent and results in the breakdown and rebuilding of a VM's session with the FCF.

Another method of executing such modifications may be accomplished by introducing new messaging and operations to the FIP. The new messaging and operations are intended to prepare the Ethernet bridge to migrate the VM from one physical machine to another physical machine via a semi-automatic process that would allow the VM's FC session to remain connected. For example, a virtual machine on Host 114 shown in FIG. 1 can migrate to Host 116 without logging out of the fabric. As part of the migration process, the ACL in Ethernet bridge 106 is updated to the delete the MAC address of the VM, and the ACL in Ethernet bridge 108 is updated to add the MAC address of the VM. New FIP messages may include a deregister message, a register message, and corresponding acceptance messages.

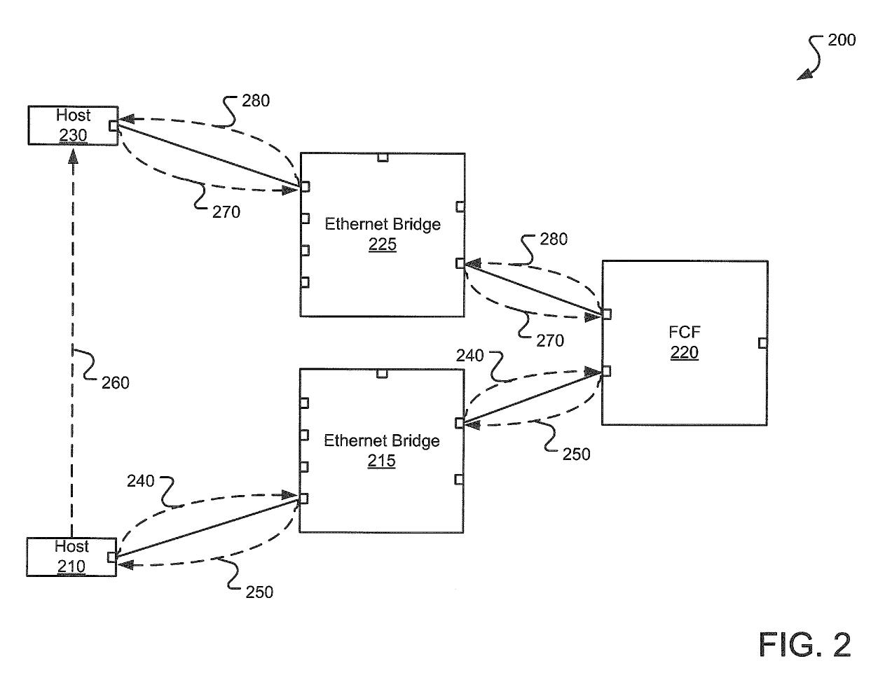

FIG. 2 illustrates an exemplary migration of a virtual machine (VM) from a first physical machine to a second physical machine using a deregister message and a register message. A deregister message includes a MAC address of the VM and is addressed to a FCF. The deregister message instructs the FCF to suspend the fabric session of the VM and may specify a duration for the suspension of the fabric session. In an implementation, if a register message is not received by the FCF from the VM during the suspension, the fabric session may be terminated. In another implementation, the fabric session may be resumed if a register message is not received by the FCF from the VM during the suspension.

Turning to FIG. 2, the VM is stored on a Host 210 which is connected to a Fibre Channel Forwarder (FCF) 220 via an Ethernet bridge 215. The VM issues a deregister message 240, addressed to the FCF 220, to instruct the FCF 220 to temporarily suspend a fabric session with the VM but not to terminate it. The intervening Ethernet bridge 215 detects the deregister message 240 using, for example, FIP snooping.

In response to receipt of the deregister message 240 by the FCF 220, the FCF 220 temporarily suspends the fabric session with the VM. Once the FCF 220 has successfully processed the deregister message from the VM, it will not accept any other normal traffic from the VM until a register message is successfully processed by the FCF 220. The FCF 220 returns a deregister acceptance message 250 through the Ethernet bridge 215 to the VM on the Host 210. The deregister acceptance message includes the MAC address of the VM. The intervening Ethernet bridge 215 detects the deregister acceptance message 250 using, for example, FIP snooping. In response to detection (e.g., snooping) of the deregister acceptance message 250 by the Ethernet bridge 215, the Ethernet bridge 215 removes the rule (e.g., the ACE) containing the MAC address of the VM specified in the deregister message 240 and the deregister acceptance message 250 from its Access Control List (ACL).

In one implementation, in response to receipt of the deregister message, the FCF may also suspend checking for a loss of Link Keep Alive messaging for a predefined duration.

Upon receipt of the deregister acceptance message 250, the VM can migrate 260 from the current physical machine 210 to a new physical machine (Host) 230 that is connected to the fabric via a different Ethernet bridge 225. In one implementation, the entire state of the VM is encapsulated by a set of files stored on shared storage and the virtual file system allows both the original physical machine and the new physical machine to access the VM state files concurrently. The active memory and execution state of the VM can then be transmitted over a high speed network. The VM can also retain its network identity (e.g., its MAC address) and during the migration.

In another implementation, the ACL of the Ethernet bridge may be updated based on the deregister message, rather than the deregister acceptance message. In yet another implementation, if a deregister acceptance message is not received by the VM within a predetermined or programmed interval, the VM may retransmit the deregister message. In still another implementation, when an FCF receives a duplicate deregister message, the FCF may return a deregister acceptance message.

After the VM migrates from the Host 210 to the Host 230, the VM issues a register message 270, including the MAC address of the VM, addressed to the FCF 220. The register message 270 instructs the FCF 220 to resume the fabric session between the FCF 220 and the VM. The intervening, newly-connected Ethernet bridge 225 detects the register message 270 using, for example, FIP snooping. In response to receipt of the register message 270 by the FCF 220, the FCF 220 resumes the fabric session between the FCF 220 and the VM and returns a register acceptance message 280 through the Ethernet bridge 225 to the VM. The register acceptance message includes the MAC address of the VM. The Ethernet bridge 225 detects the register acceptance message 280 using, for example, FIP snooping. Detection of the register acceptance message 280 causes the Ethernet bridge 225 to add the MAC address of the VM to its ACL at the new physical port location. In response to detection (e.g., snooping) of the register acceptance message 280 by the newly-connected Ethernet bridge 225, the Ethernet bridge 225 adds the rule (e.g., the ACE) containing the MAC address of the VM found in register message 270 and register acceptance message 280 to its ACL. The VM then resumes frame communications through newly-connected Ethernet bridge 225 and FCF 220.

In another implementation, the ACL of the Ethernet bridge may be updated based on the register message, rather than the register acceptance message. In yet another implementation, in response to receipt of the register message, the FCF may also resume checking for loss of Link Keep Alive messaging. In still another implementation, if a register acceptance message is not received by the VM within a predetermined or programmed interval, the VM may retransmit the register message. In an implementation, if an FCF receives a duplicate register message, the FCF returns a register message.

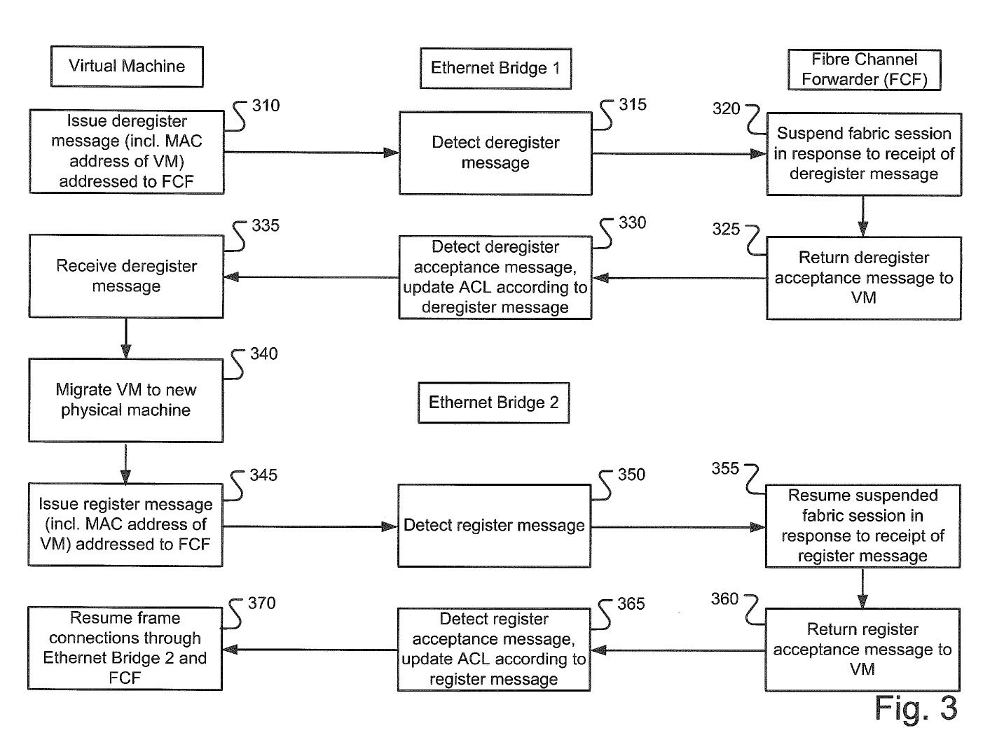

FIG. 3 illustrates exemplary operations for managing an Access Control List (ACL) in a Fibre Channel over Ethernet (FCoE) environment. In operation 310, a virtual machine (VM) stored on a first physical machine issues a deregister message addressed to a Fibre Channel Forwarder (FCF) of a fabric in a Fibre Channel over Ethernet (FCoE) network. The deregister message includes the MAC address of the VM and instructs the FCF to suspend the fabric session of the VM. Additionally, the deregister message may specify a duration for the suspension of the fabric session. The deregister message is transmitted through an Ethernet bridge to the FCF. In operation 315, the Ethernet bridge detects the deregister message issued to the FCF. The Ethernet bridge may use FIP snooping to detect the deregister message.

In operation 320, the FCF receives the deregister message from the VM through the Ethernet bridge, and temporarily suspends the fabric session with the VM, but does not terminate the fabric session with the VM. While the fabric session is suspended, the FCF will not accept other traffic from the VM until the FCF receives instructions to resume the suspended fabric session. In operation 325, the FCF acknowledges receipt of the deregister message by returning a deregister acceptance message to the VM through the Ethernet bridge. The Ethernet bridge detects the deregister acceptance message in operation 330 using, for example, FIP snooping. The deregister acceptance message may include the MAC address of the VM. When the deregister acceptance message is detected, the Ethernet bridge updates its Access Control List (ACL) by removing the MAC address associated with the VM in accordance with the previously detected deregister message.

In operation 335, the VM receives the deregister message. The VM migrates to a new or different physical machine in operation 340. In operation 345, the newly migrated VM issues a register message addressed to the FCF of the fabric. The register message includes the MAC address of the VM, and contains instructions to resume the suspended fabric session. The register message is sent by the VM through a second Ethernet bridge to the FCF. In operation 350, the register message is detected by the second Ethernet bridge via, for example, FIP snooping. In operation 355, the FCF receives the register message and resumes the suspended fabric session in accordance with the instructions contained in the register message. In operation 360, the FCF returns a register acceptance message to the VM through the second Ethernet bridge.

The second Ethernet bridge detects the register acceptance message in operation 365, and updates its Access Control List (ACL) in accordance with the register message. Thus, the second Ethernet bridge adds the MAC address associated with the VM to its ACL. In operation 370, the VM resumes frame connections through the second Ethernet bridge and the FCF.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method, comprising:
sending a deregister message through an Ethernet bridge to a Fibre Channel Forwarder (FCF) of a fabric in a Fibre Channel over Ethernet (FCoE) network, the deregister message including a MAC address of a virtual machine (VM) and instructing the FCF to temporarily suspend its fabric session with the VM.

2. A method according to claim 1, wherein the deregister message further instructs the FCF to suspend checking for a loss of Link Keep Alive messaging for a predefined duration.

3. A method according to claim 1, wherein the deregister message further instructs the FCF to suspend the fabric session for a predetermined period of time.

4. A method according to claim 1, further comprising:
initiating migration of the virtual machine from a first physical machine to a second physical machine, after sending the deregister messages through the Ethernet bridge to the FCF.

5. A method according to claim 1, further comprising:
detecting the deregister acceptance message at Ethernet bridge coupled between the VM and the FCF; and
updating an Access Control List (ACL) of the Ethernet bridge by removing the MAC address of the VM.

6. A method according to claim 5, further comprising:
detecting the deregister message at the Ethernet bridge using Fibre Channel over Ethernet Initialization Protocol (FIP) snooping.

7. A method according to claim 1, further comprising:
sending a deregister acceptance message from the FCF through the Ethernet bridge to the VM to acknowledge receipt of the deregister message at the FCF.

8. A method according to claim 7, further comprising:
detecting the deregister acceptance message at the Ethernet bridge; and
updating the Access Control List (ACL) of the Ethernet bridge by removing the MAC address of the VM.

9. A method, comprising:
migrating a virtual machine connected to a fabric in a Fibre Channel over Ethernet (FCoE) network from a first physical machine in the FCoE network to a second physical machine in the FCoE network while maintaining a connection with the fabric.

10. A method according to claim 9, wherein the fabric connection is suspended during the migrating.

11. A method, comprising:
sending a register message through an Ethernet bridge to a Fibre Channel Forwarder (FCF) of a fabric in a Fibre Channel over Ethernet (FCoE) network, the register message including the MAC address of a virtual machine (VM) and instructing the FCF to resume a fabric session with the VM.

12. A method according to claim 11, further comprising:
receiving migration of the VM before sending the register message.

13. A method according to claim 11, wherein the register message further instructs the FCF to resume checking for a loss of Link Keep Alive messaging.

14. A method according to claim 11, further comprising:
detecting the register message at the Ethernet bridge; and
adding the MAC address of the VM to an Access Control List (ACL) of the Ethernet bridge.

15. A method according to claim 11, further comprising:
sending a register acceptance message from the FCF to the VM through the Ethernet bridge to acknowledge receipt of the register message at the FCF.

16. A method according to claim 11, further comprising:
detecting the register acceptance message from the FCF at the Ethernet bridge; and
adding the MAC address of the VM to an Access Control List (ACL) of the Ethernet bridge.

17. A method, comprising:
updating an Access Control List (ACL) of an Ethernet bridge connectable to a Fibre Channel over Ethernet (FCoE) network based on a detected message.

18. A method according to claim 17, wherein the detected message is destined for an FCF in the FCoE network.

19. Apparatus, comprising:
an Ethernet bridge including memory storing an Access Control List (ACL) configured to detect a message addressed to another device on a FCoE network, wherein the Ethernet bridge updates the ACL in accordance with the detected message.

20. Apparatus according to claim 19, wherein the Ethernet bridge is communicatively coupled to a virtual machine (VM) and adds a MAC address of the VM to the ACL in response to detection of a register message.

21. Apparatus according to claim 19, wherein the Ethernet bridge is communicatively coupled to a virtual machine (VM) and adds a MAC address of a VM to the ACL in response to detection of a register acceptance message.

22. Apparatus according to claim 19, wherein the Ethernet bridge is communicatively coupled to a virtual machine (VM) and removes a MAC address of a VM from the ACL in response to detection of a deregister message.

23. Apparatus according to claim 18, wherein the Ethernet bridge is communicatively coupled to a virtual machine (VM) and removes a MAC address of a VM from the ACL in response to detection of a deregister acceptance message.

24. Apparatus, comprising:
a Fibre Channel Forwarder (FCF) device configured to suspend and restore a fabric session with a virtual machine.

25. Apparatus according to claim 24, wherein the FCF is further configured to suspend the fabric session with a virtual machine in response to receipt of a deregister message.

26. Apparatus according to claim 24, wherein the FCF is further configured to resume the fabric session with a virtual machine in response to receipt of a register message.

27. A system, comprising:
a Fibre Channel Forwarder (FCF) device configured to suspend and restore fabric sessions on an FCoE network;
a first Ethernet bridge including a memory storing an Access Control List (ACL) and configured to detect a deregister message addressed to the FCF and update the ACL in accordance with the deregister message; and
a second Ethernet bridge including a memory storing an Access Control List (ACL) and configured to detect a register message addressed to the FCF and update the ACL in accordance with the register message.
